(19) United States
(12) Patent Application Publication
(10) Pub. No.: US 2004/0266344 A1
(43) Pub. Date: Dec. 30, 2004

(54) Integrated AM/FM mast with single SDARS antenna

(76) Inventors: Imtiaz Zafar, Sterling Heights, MI (US); Ahmad B. Pakray, Rochester Hills, MI (US); Kenneth P. Lee, Bingham Farms, MI (US); J. Robert Dockemeyer JR., Kokomo, IN (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/607,868

(22) Filed: Jun. 27, 2003

(51) Int. Cl. H04Q 7/20

(52) U.S. Cl. 455/13.3

(57) ABSTRACT

An combined satellite and terrestrial antenna system for a structure is disclosed. The antenna system that includes a terrestrial antenna, a satellite antenna, a satellite receiver, and an AM/FM receiver. The terrestrial antenna includes a multi-band terrestrial antenna mounted on a mounting assembly including a low noise amplifier circuit and a bezel. The bezel is adapted to contain the low noise amplifier. The satellite antenna is concentrically mounted with respect to the terrestrial antenna. The mounting assembly is connected to the satellite receiver for reception of satellite and satellite retransmitted signals by a satellite-terrestrial-retransmitted-satellite cable. The mounting assembly is also connected to the AM/FM receiver for reception of AM/FM terrestrial signals by a terrestrial AM/FM cable. A method for mounting the combined satellite and terrestrial antenna system on a structure is also disclosed. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

The invention relates generally to radio antennas. More particularly, the invention relates to terrestrial radio and satellite communication antennas for vehicles and other mobile or fixed structures. The invention also relates to an integral antenna assembly that comprises one or more antennas for mounting externally on the surface of a vehicle or other mobile or fixed structure.

### BACKGROUND OF THE INVENTION

With reference to FIGS. 1 and 2, a number of antenna systems have been proposed which provide for the reception of satellite transmission signals on vehicles and other mobile or fixed structures. FIG. 1 illustrates a known antenna system that allows transfer of radio frequency (RF) energy across a dielectric such as glass for reception of satellite transmitted signals. The antenna illustrated in FIG. 1 provides for the transfer of RF energy through glass or other dielectric surface to avoid having to drill holes, for example, through the windshield or window of an automobile for installation. After-market glass-mount antenna systems are advantageous because they obviate the necessity of having to provide a proper seal around an installation hole or other window opening in order to protect the interior of the vehicle and its occupants from exposure to external weather conditions.

In the known antenna system 1a depicted in FIG. 1, RF signals from an antenna 2a are conducted across a glass surface 3a via a coupling device 4a that typically employs capacitive coupling, slot coupling or aperture coupling. The portion of the coupling device 4a on the interior of the vehicle is connected to a matching circuit 5a which provides the RF signals to a low noise amplifier (LNA) 7a at the input of a receiver 8a via an RF or coaxial cable 6a.

FIG. 2 illustrates an alternative embodiment of the antenna system 1a of FIG. 1 at reference numeral 1b, except that antenna 2b has been displaced to the roof of a vehicle, V, and is kept in place by a magnet or other securing means. Through cable 3b, the RF signal travels to coupler 4b, which is mounted exteriorly on the vehicle's glass (e.g., back windshield) and to second coupler 4b, which is mounted on the glass, such that the second coupler 4b is positioned on the interior of the vehicle, V, in a directly opposing relationship to the first coupler 4b mounted on the exterior of the glass. The RF signal then travels through RF cable 5b to LNA 6b and then through RF cable 7b to receiver 8b.

Both types of antenna mounting systems 1a, 1b illustrated in FIGS. 1 and 2 suffer from various deficiencies. First, the antennas 2a, 2b of FIGS. 1 and 2, respectively, is, in all likelihood, a second or even third antenna positioned on the vehicle (i.e. an additional antenna in view of the original equipment manufacture (OEM)-installed AM/FM antenna), and thus adds an unsightly appearance to the vehicle, V. Regarding the window mount antenna system 1a, RF coupling loss through the glass 3a is generally 1 dB or higher. This causes an increase in noise that results in degradation of receiver sensitivity. Even further, the couplers 4a may obstruct vehicle operator vision while also generally making the appearance of the vehicle, V, unsightly.

The vehicle body mount (i.e. roof mount) antenna system 1b includes other maintenance, safety, and performance issues. For example, the installation of antenna 2b is located remotely with respect to LNA 6b and radio receiver 8b, which is generally considered unattractive to consumers of mobile satellite services, such as SDARS. This is true for several reasons. First, the roof mounted antenna 2b is unsightly, not only to the external observer, but also to the vehicle occupants where the RF cables 5b, 7b must be routed through the interior of the vehicle, V. Secondly, as a result of height restrictions on car carriers, truck carriers, or other vehicle carriers, an antenna 2b placed on the roof has to be below some maximum height, such that the overall vehicle height does not exceed the maximum allowable height whereby this causes a problem with being loaded on a carrier. Even further, an antenna 2b that is mounted on the roof of the vehicle, V, adds to the clearance height of the vehicle, V, which may be troublesome if parking the vehicle, V, in a garage. Often, users will forget that the antenna 2b is on the roof, and will cause damage either to the antenna 2b and/or the vehicle, V. Even further, if the user minds the fact that the antenna is mounted on the roof, the user may have to stop the vehicle, V, exit it, and dismantle the antenna 2b before parking in the garage.

FIG. 3 illustrates an alternative embodiment of the antenna system at reference numeral 1c. The antenna system 1c includes a combined multi-band terrestrial and satellite antenna system installed on a vehicle for reception of AM, FM, satellite and terrestrial retransmitted satellite signals. The combined multi-band terrestrial/satellite antenna system 1c includes a multi-band terrestrial antenna 2c, satellite antenna 3c, bezel 4c, nut 5c, bolt 6c, LNA housing 7c, SDARS satellite (SDARS/SAT) cable 8c, SDARS terrestrial (SDARS/TER) cable 9c, and AM/FM cable 10c. The system further comprises SDARS receiver (SDARS/RX) 11c, SDARS audio cable 12c, and combined head unit and AM/FM tuner 13c, which includes an AM/FM tuner 14c and head unit 15c.

The multi-band terrestrial antenna 2c includes a folded-dipole and is used to receive conventional AM and FM transmitted signals and terrestrial retransmission of satellite transmitted signals while the satellite antenna 3c includes a helical element to receive satellite transmitted signals directly. Essentially, the antennas 2c, 3c are two distinct antennas, as applied to SDARS signals (i.e. direct satellite signals and retransmitted terrestrial signals), that are physically separated, requiring three cables that function in providing the satellite signal (SDARS/SAT cable 8c), the terrestrial retransmitted satellite signals (SDARS/TER cable 9c), and the AM/FM terrestrial signals (AM/FM cable 12c). Both antennas 2c, 3c are secured through the mounting hole provided in a surface 16c, via the nut 5c and bolt 6c. The SDARS/SAT cable 8c, SDARS/TER cable 9c and AM/FM cable 10c pass through bolt 6c, which has a suitably large hollowed-out portion to pass the three cables 8c, 9c, 10c through. If desired, the surface 16c may be the surface of an automobile, and the combined terrestrial/satellite antenna system 1c may be located on a manufacturer-provided hole (i.e. one that the original equipment manufacturer (OEM) provides for the purpose of installing an AM/FM mast antenna). The three cables 8c, 9c, 10c provide a communication path to other components of the system as explained above and seen at reference numerals 11c-15c, which, for example, may be located in the trunk of the vehicle. Functionally, the SDARS/SAT cable 8c carries the amplified received satellite signal, the SDARS/TER cable 9c carries the amplified terrestrial retransmission of a satellite (or cellular) signal, and the AM/FM cable 10c carries the AM/FM terrestrial signals received by multi-band antenna 2c.

Referring to FIG. 4, a schematic block diagram of the combined multi-band terrestrial and satellite antenna system 1c is seen generally at reference numeral 17c. The satellite antenna 3c includes a satellite antenna output cable 18c. The multi-band terrestrial antenna 2c includes a multi-band terrestrial antenna output cable 19c. The cable 18c is input to the LNA housing 7c such that it is connected directly to a satellite low-noise amplifier (SAT/LNA) 20c, the output of which is the SDARS/SAT cable 8c. The cable 19c is input to the LNA housing 7c such that it is connected directly to a combiner 21c, the output of which are the SDARS/TER cable 9c and AM/FM cable 10c, both of which connects to an SDARS/AM/FM splitter 22c that isolates the AM/FM and terrestrial retransmitted satellite signals. The SDARS/RX 11c receives SDARS/SAT cable 8c and the first output of SDARS/AM/FM splitter 22c, which is an SDARS cable 23c. The second output of SDARS/AM/FM splitter 22c is AM/FM splitter cable 24c, which is input to AM/FM tuner 14c, the output of which is connected to head unit 15c via AM/FM tuner output cable 25c. The head unit 15c also receives a down-converted satellite transmission signal output from SDARS/RX 11c that the head unit 15c can then process and convert to an audio signal. The down-converted signal is carried by SDARS/Audio cable 12c, which extends from the SDARS/RX 11c. Likewise, the output of AM/FM tuner 14c is a down-converted signal which the head unit 15c can process and output as audio, to speakers (not shown).

Mounting the satellite antenna 3c around multi-band terrestrial antenna 2c, which is itself mounted in an OEM-supplied hole, prevents the necessity of cutting an additional hole in a vehicle or structure and thereby avoids destroys the exterior finish and/or appearance of the vehicle. Even further, the mounting of the satellite antenna 3c also eliminates the need to use a magnet (for a roof mounted system) or through-the-glass couplers (for window mounted systems). Although adequate for most applications, longer lengths of the cables 8c, 9c, 10c may significantly increase cable loss and thereby impair the capability (i.e., decrease the signal-to-noise ratio and hence the sensitivity) of the radio. Even further, increased length and numbers of cables 8c, 9c, 10c increases the overall cost of the antenna system 1c.

A need therefore exists for an antenna that eliminates and reduces the number and length of the cables while also reducing the number of components used in the manufacture of the antenna system. A need also exists for a vehicle antenna mounting system whereby both types of antenna (i.e., a vehicle's OEM supplied AM/FM antenna and an antenna for the reception of SDARS signals) can be co-located, so as to minimize, if not entirely prevent, any additional holes in a vehicle's exterior shell or eliminate the need to locate a magnetically mounted antenna on the glass of a vehicle, or to use antenna couplers in the glass portion of a vehicle, yet provide an integral assembly for installation on the exterior of a vehicle, and an effective means for reception of both terrestrial AM/FM signals and satellite transmitted signals.

### SUMMARY OF THE INVENTION

The present invention relates to a combined satellite and terrestrial antenna system for a structure. Accordingly, one embodiment of the invention is directed to an antenna system that includes a terrestrial antenna, a satellite antenna, a satellite receiver, and an AM/FM receiver. The terrestrial antenna includes a multi-band terrestrial antenna mounted on a mounting assembly including a low noise amplifier circuit and a bezel. The bezel is adapted to contain the low noise amplifier. The satellite antenna is concentrically mounted with respect to the terrestrial antenna. The mounting assembly is connected to the satellite receiver for reception of satellite and satellite retransmitted signals by a satellite-terrestrial-retransmitted-satellite cable. The mounting assembly is also connected to the AM/FM receiver for reception of AM/FM terrestrial signals by a terrestrial AM/FM cable. A method for mounting the combined satellite and terrestrial antenna system on a structure is also disclosed.

### BRIEF DESCRIPTION OF THE DRAWINGS

The novel features and advantages of the present invention will best be understood by reference to the detailed description of the specific embodiments which follows, when read in conjunction with the accompanying drawings, in which.

FIG. 1 illustrates a known antenna system that allows inductive transfer of RF energy across a dielectric such as glass for reception of satellite transmitted signals;

FIG. 2 illustrates an alternative known embodiment of the antenna system of FIG. 1 mounted on a vehicle;

FIG. 3 illustrates a known combined multi-band terrestrial and satellite antenna system installed on a vehicle for reception of AM, FM, satellite and terrestrial re-transmitted satellite signals;

FIG. 4 is a known schematic block diagram of a combined multi-band terrestrial and satellite antenna system for reception of AM, FM, satellite and terrestrial re-transmitted satellite signals according to another embodiment of the invention according to FIG. 3;

FIG. 5A illustrates a combined multi-band terrestrial and satellite antenna system installed on a vehicle for reception of AM, FM, satellite and terrestrial re-transmitted satellite signals according to one embodiment of the present invention;

FIG. 5B illustrates a combined multi-band terrestrial and satellite antenna system installed on a vehicle for reception of AM, FM, satellite and terrestrial re-transmitted satellite signals according to another embodiment of the present invention;

FIG. 6 illustrates a quadrifilar antenna etched on a flexible substrate that may be used in a combined multi-band terrestrial/satellite antenna according to the embodiments of the invention as shown in FIGS. 5A and 5B;

FIG. 7A illustrates the mechanical configurations of a combined multi-band terrestrial/satellite antenna according to another embodiment of the present invention;

FIG. 7B illustrates the mechanical configurations of a combined multi-band terrestrial/satellite antenna according to another embodiment of the present invention;

FIG. 7C illustrates the mechanical configurations of a combined multi-band terrestrial/satellite antenna according to another embodiment of the present invention;

FIG. 8 is a schematic block diagram of a combined multi-band terrestrial and satellite antenna system for reception of AM, FM, satellite and terrestrial re-transmitted satellite signals according to the embodiments of the invention as described in FIGS. 5A-7C;

FIG. 9A illustrates the installation of a combined multi-band terrestrial/satellite antenna in a vehicle according to one embodiment of the invention; and

FIG. 9B-9E each illustrate the installation of a combined multi-band terrestrial/satellite antenna in a vehicle according to another embodiment of the invention.

### DETAILED DESCRIPTION OF THE PREFERRED EMBODIMENTS

The various features of the preferred embodiment will now be described with reference to the drawings, in which like parts are identified with the same reference characters.

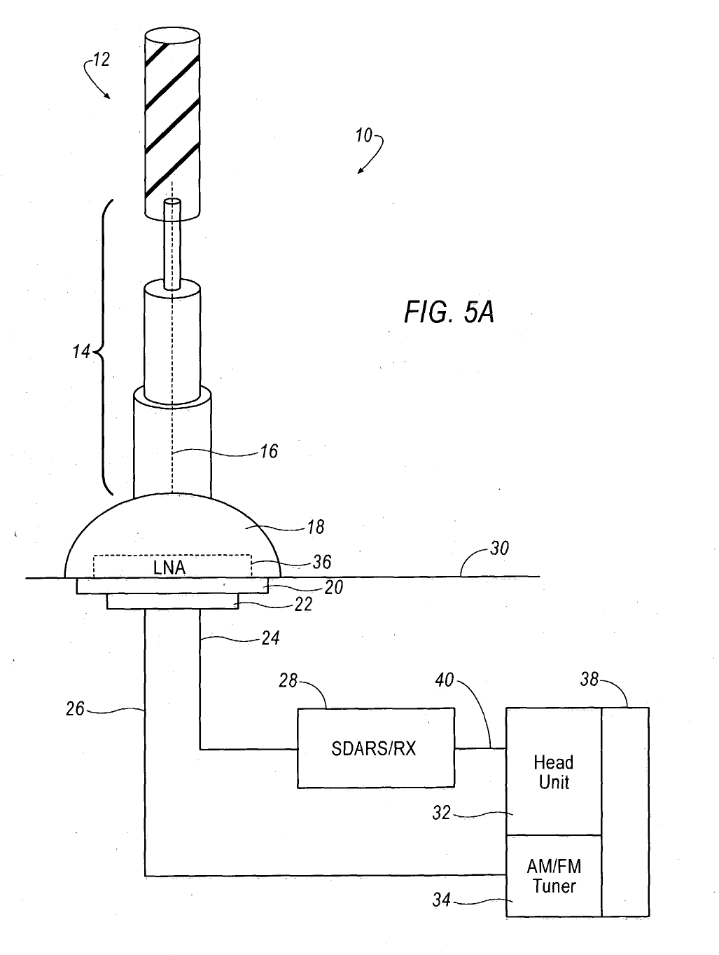

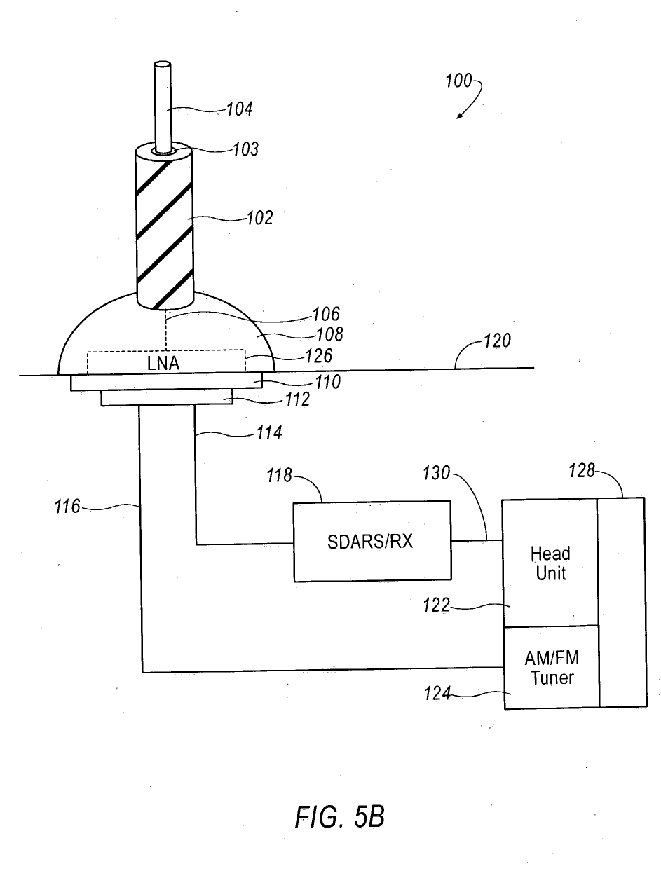

FIGS. 5A and 5B each illustrates a combined multi-band terrestrial and satellite antenna system installed on a vehicle for reception of AM, FM, satellite and terrestrial re-transmitted satellite signals according to an embodiment of the present invention. Referring to both FIGS. 5A and 5B, the combined multi-band terrestrial/satellite antenna system 10 (FIG. 5A), 100 (FIG. 5B) comprises a single element satellite and terrestrial antenna 12, 102 and an AM/FM terrestrial antenna 14, 104. Primarily, the multi-band terrestrial antenna 14, 104 is used for AM and FM radio reception. AM and FM radio is generally used for audio reception only, that is, for transmissions from local radio stations with various programming formats, including music, news, sports, “talk radio”, and so on. These programming formats are familiar to many people and are the kind that are commonly received by users in their vehicles and mobile or fixed structures today. However, multi-band terrestrial antenna 14, 104 may also be used for two-way cellular telephony and for reception of terrestrial retransmission of a satellite transmitted signal. It is known that radio frequency transmissions are often subject to multipath fading; this is especially true of satellite transmitted signals. Signal blockages at receivers can occur due to physical obstructions between a transmitter and the receiver or service outages. For example, mobile receivers encounter physical obstructions when they pass through tunnels or travel near buildings or trees that impede line of sight (LOS) signal reception. Service outages can occur when noise or multipath signal reflections are sufficiently high with respect to the desired signal. At these times, when a direct line-of-sight transmission path between the satellite and single element satellite and terrestrial antenna 12, 102 is blocked, retransmission of the satellite signals from terrestrial retransmitters is very useful. The single element satellite and terrestrial antenna 12, 102 is designed to receive satellite transmission signals directly from one or more satellites placed in synchronous or non-synchronous earth orbits, and terrestrial transmission signals from terrestrial repeaters. Satellite transmissions may be used for audio programming, but can be used for other purposes as well.

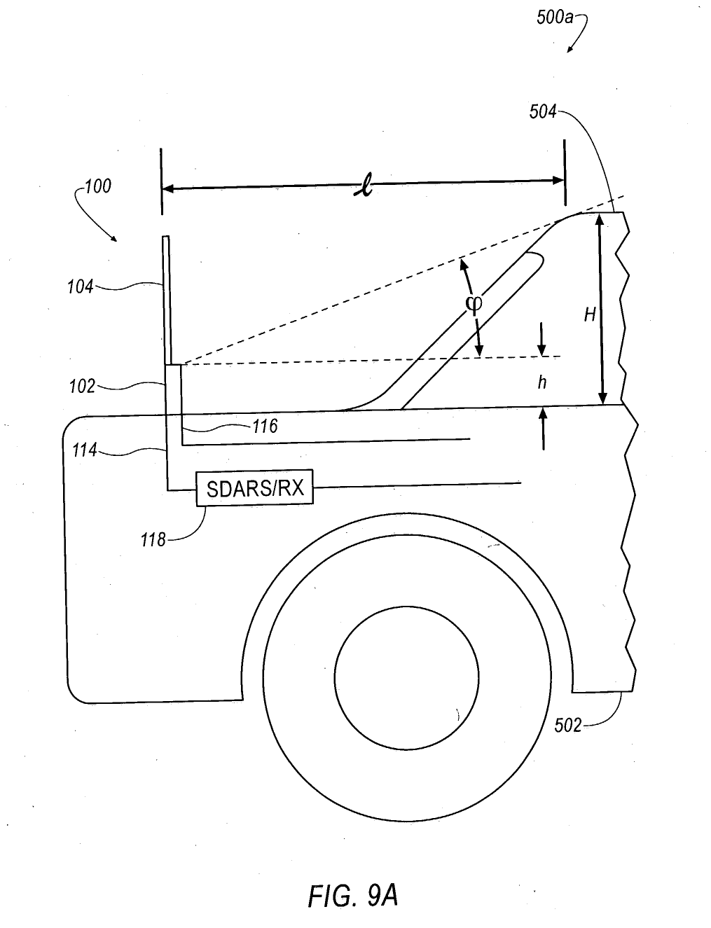

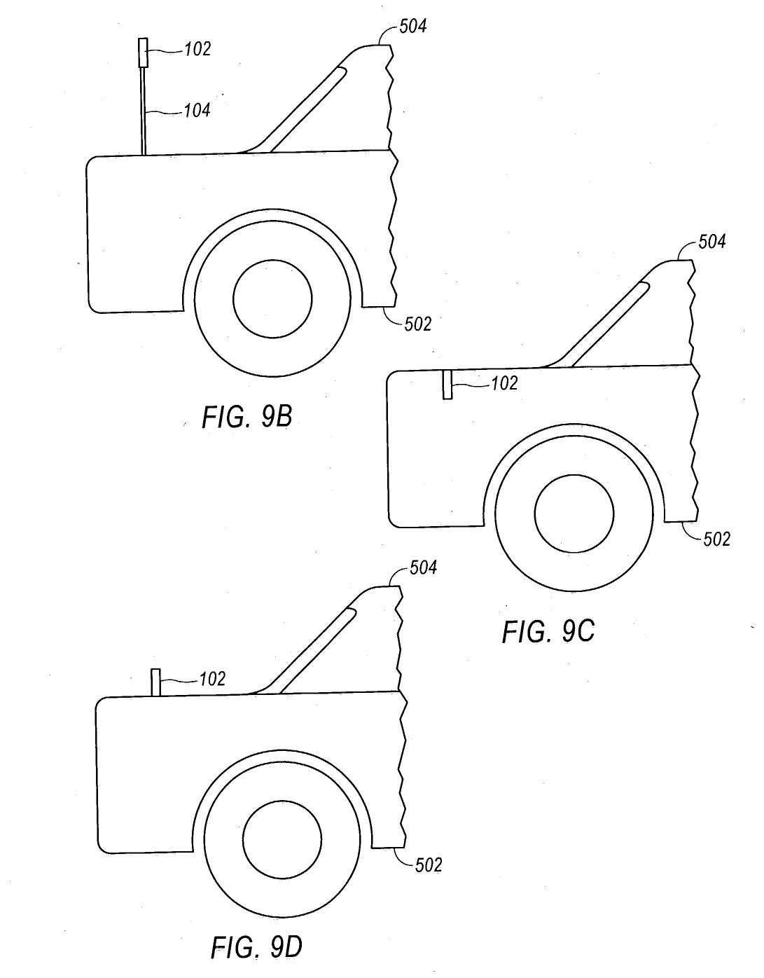

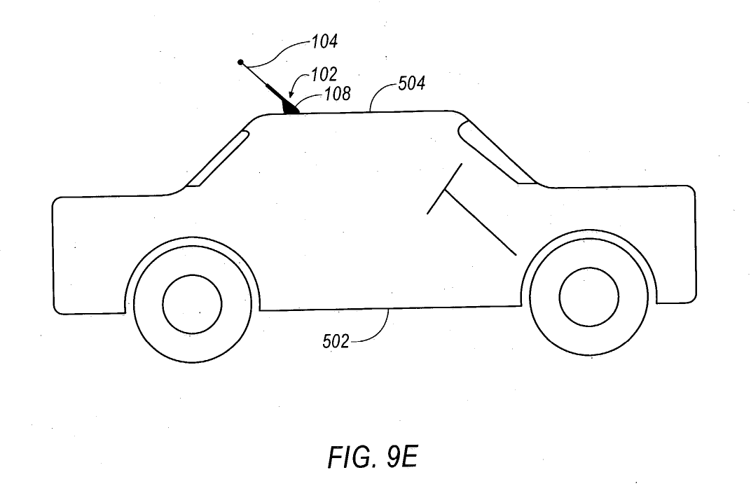

The combined multi-band terrestrial/satellite antenna system 10, 100 also includes a coaxial cable 16, 106, a bezel 18, 108, a nut 20, 110, a bolt 22, 112, a low noise amplifier (LNA) housing 36, 126, a SDARS satellite-terrestrial (SDARS/SAT/TER) cable 24, 114, and AM/FM cable 26, 116. The system further comprises an SDARS receiver (SDARS/RX) 28, 118, an SDARS audio cable 40, 130, and combined head unit and AM/FM tuner 38, 128. The combined head unit and AM/FM tuner 38, 128 includes an AM/FM tuner 34, 124 and head unit 32, 122. The AM/FM terrestrial antenna 14, 104 is used to receive conventional AM and FM transmitted signals. In other embodiments, it may receive and transmit cellular telephone signals, for example. Single element satellite and terrestrial antenna 12, 102 may receive satellite and terrestrial transmitted signals directly. The combined multi-band terrestrial/satellite antenna system 10, 100 is shown mounted on a surface 30, 120, which might be the surface (i.e. fender or roof) of an automobile or other vehicle (FIGS. 9A-9E). Alternatively, the surface 30, 120 of many other fixed or mobile structures. As illustrated, the surface 30, 120 supports the bezel 18, 108.

As can be seen in FIGS. 5A and 5B, the AM/FM terrestrial antenna 14, 104 is concentrically mounted within the single element satellite and terrestrial antenna 12, 102. Both antennas are secured through a mounting hole (not shown) provided in surface 30, 120 via the nut 20, 110 and bolt 22, 112. The two antennas are mounted on bezel 18, 108, which allows the antenna to always be vertical, even if surface 30, 120 is somewhat slanted. The SDARS/SAT/TER cable 24, 114 and AM/FM cable 26, 116 pass through bolt 22, 112, which has a suitably large hollowed-out portion to pass the cable pair (i.e. cables 24, 26 and 114, 116) through. The LNA housing 36, 126, may, according to an embodiment of the invention, reside within bezel 18, 108. Other configurations of LNA housing 36, 126 are possible. The bezel 18, 108, LNA housing 36, 126 (and its components), nut 20, 110, and bolt 22, 112 comprise a mounting assembly.

If the surface 30, 120 is the surface of an automobile, the combined terrestrial/satellite antenna system 10, 100 may have been located on a manufacturer-provided hole (i.e., one that the automobile manufacturer provided for the purpose of installing an AM/FM mast antenna). As such, no additional holes are needed, which eliminates the danger of corrupting the protective paint and/or rust-inhibiting materials applied by the manufacturer. The single element satellite antenna 12, 102 and multi-band terrestrial antenna 14, 104 can occupy only one space and utilize only one hole in a vehicle or structure's body, yet can provide access to at least two different services, as will be described in detail below. With regard to the discussion and the Figures, the use of the combined multi-band terrestrial/satellite antenna system 10, 100 will be as if it were placed on an automobile; however, as will be discussed in detail below, combined multi-band terrestrial/satellite antenna system 10, 100 may be used with various vehicles and structures.

The single element satellite antenna 12, 102 and AM/FM terrestrial antenna 14, 104 may be located in any desirable implementation. For example, as illustrated in FIG. 5A, the terrestrial antenna 14 is a retractable or fixed mast antenna that is positioned concentrically within the single element satellite and terrestrial antenna 12 such that the coaxial cable 16 extends through the terrestrial antenna 14 to provide a signal communication path for the satellite antenna 12. Referring to FIG. 5B, it can be seen that single element satellite and terrestrial antenna 102 is placed concentrically around a fixed AM/FM terrestrial antenna 104. The single element satellite and terrestrial antenna 102 includes a terrestrial antenna bore 103 to receive the AM/FM terrestrial antenna 104. The terrestrial antenna bore 103 is located at or near the center of single element satellite and terrestrial antenna 102 and is large enough to slide over the AM/FM terrestrial antenna 104 such that an application of mounting glue or epoxy will stay firmly in contact with the terrestrial antenna 104. The single element satellite and terrestrial antenna 102 is placed around a spacer (not shown), within which is formed terrestrial antenna bore.

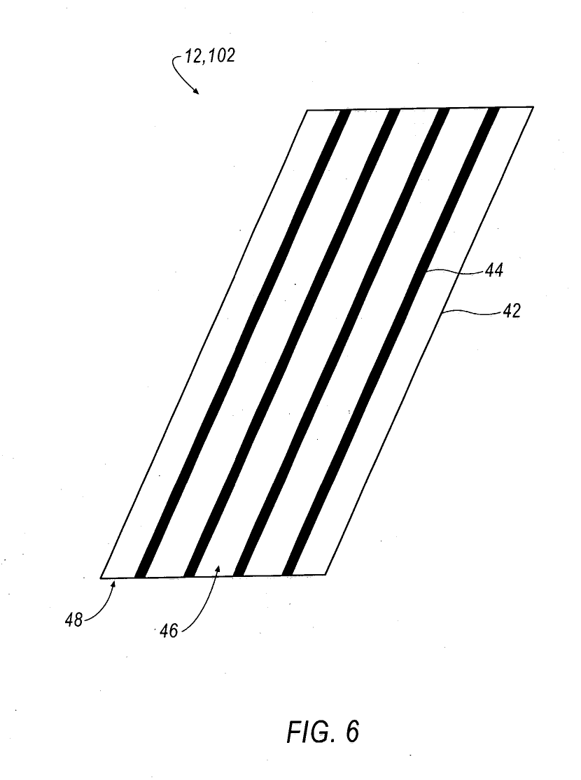

In both embodiments of the invention as illustrated in FIGS. 5A and 5B, the LNA housing 36, 126 is located at the base of combined the multi-band terrestrial/satellite antenna 10, 100. In one embodiment, LNA housing 36, 126 is designed to be concealed within bezel 18, 108. In different embodiments, the LNA housing 18, 108 might be located several feet away or directly below surface 30, 120 from combined multi-band terrestrial/satellite antenna 10, 100. Also, the single element satellite and terrestrial antenna 12, 102, as illustrated in both embodiments, is preferably a quadrifilar helix antenna (FIG. 6). Although the retractable mast antenna of FIG. 5A illustrates the single element satellite and terrestrial antenna 12 positioned at the top of the AM/FM terrestrial antenna 14, and the fixed antenna of FIG. 5B illustrates the single element satellite and terrestrial antenna 102 positioned below the terrestrial AM/FM antenna 104, the illustrated embodiments of the invention do not limit the positioning and/or placement of the single element antenna 12, 102. If desired, the single element antenna 12, 102 may be positioned above or below the AM/F terrestrial antenna 14, 104 or in any other desirable orientation regardless of mechanics of the AM/FM terrestrial antenna 14, 104.

FIG. 6 illustrates a quadrifilar antenna etched on a flexible substrate that may be used, as illustrated, in the combined multi-band terrestrial/satellite antenna 10, 100. The single element antenna 12, 102 is comprised of quadrifilar helix antenna and includes conductive quadrifilar antenna elements 44 that are etched on a flexible insulating substrate 42, according to a design which is well known to those skilled in the art. A weatherproofing material may be applied to the exterior surface 46 of the substrate 42 to protect the quadrifilar antenna elements 44 from the deteriorating effects of rain, sunshine, etc. Additionally, a binding agent (not shown) may be applied to the interior surface 48 of quadrifilar antenna 12, 102 when fabricated into the final desired form as shown in FIGS. 5A and 5B. A single element satellite and terrestrial antenna that is comprised of a quadrifilar helix antenna has good performance in receiving satellite transmissions from geosynchronous orbit satellites and acceptable performance in receiving terrestrial transmissions. Since the single element satellite and terrestrial antenna 12, 102 is placed concentrically about the AM/FM terrestrial antenna 14, 104, installation of single element satellite and terrestrial antenna 12, 102 can be an after-market addition or by the original equipment manufacturer or OEM (automobile manufacturer). In both cases, the RF cables coming from both antennas will fit into the existing pre-cut hole that the existing AM/FM terrestrial antenna 14, 104 has already been mounted on.

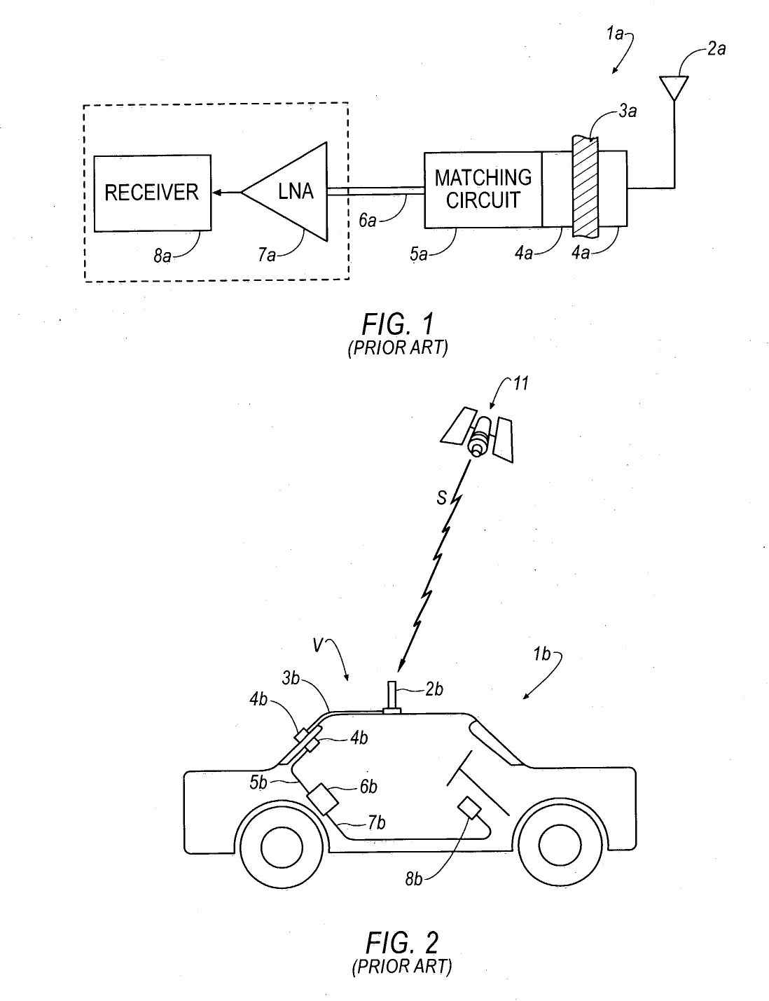

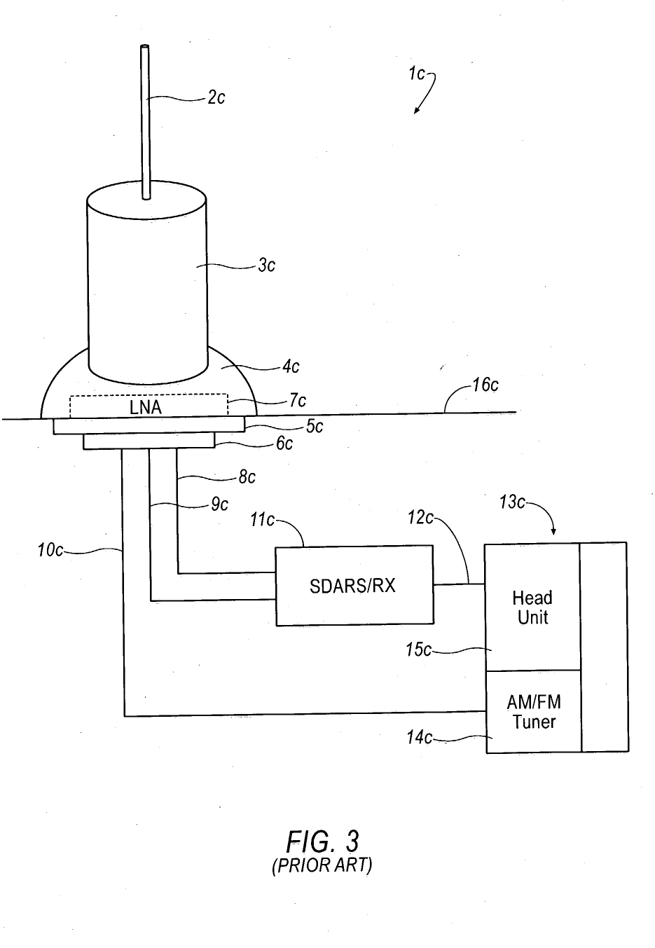

Mounting the single element satellite and terrestrial antenna 12, 102 around AM/FM terrestrial antenna 14, 104, which is itself mounted in an OEM-supplied hole, prevents the necessity of cutting an additional hole in a vehicle or structure thereby avoiding destroying the exterior finish and/or appearance of the vehicle or structure. It also eliminates the need to use a magnet (i.e. for a conventional roof mounted system, as illustrated in FIG. 2) or through-the-glass couplers (i.e. for conventional window mounted systems, as illustrated in FIG. 1). It is well known in the automotive industry that the application of paints and finishes provides a decorative and appealing uniform appearance, and prevents or inhibits the formation of rust in or on the body of the vehicle. By cutting a hole through this finish or paint, the intent of the manufacturer is circumvented in that a means for deterioration of the automotive body is provided. That is, it will be more likely than not that rust would form and water could enter and damage the interior of the vehicle. Additionally, drilling a hole in the surface of a fender of a vehicle adds the risk of chipping the paint and/or finish material, which may detract form the appearance of the vehicle. Also, placing a second antenna may be considered to be unattractive by many people.

Referring to back to FIGS. 5A and 5B, combined multi-band terrestrial/satellite antenna 10, 100 has two cables (i.e. cable pair 24, 26 and 114, 116) that lead from its base to other components of the system. The first cable is SDARS/SAT/TER cable 24, 114, which carries the amplified received satellite signal and the amplified terrestrial retransmission of a satellite (or cellular) signal received by the single element satellite and terrestrial antenna 12, 102. The second cable is. AM/FM cable 26, 116, which carries the AM/FM terrestrial signals received by AM/FM antenna 14, 104. However, because the two antennas are co-located, for example, on the trunk or front or rear fender of a vehicle, other components of combined multi-band terrestrial/satellite antenna system 10, 100 may also be located in the trunk of the vehicle. If the components are located in the trunk of a vehicle, a shorter length SDARS/SAT/TER cable 24, 114 will significantly cut down on cable loss and thereby improve the capability (i.e., increase the signal-to-noise ratio, and hence, the sensitivity) of the radio. Another advantage is the cost savings due to a shorter cable.

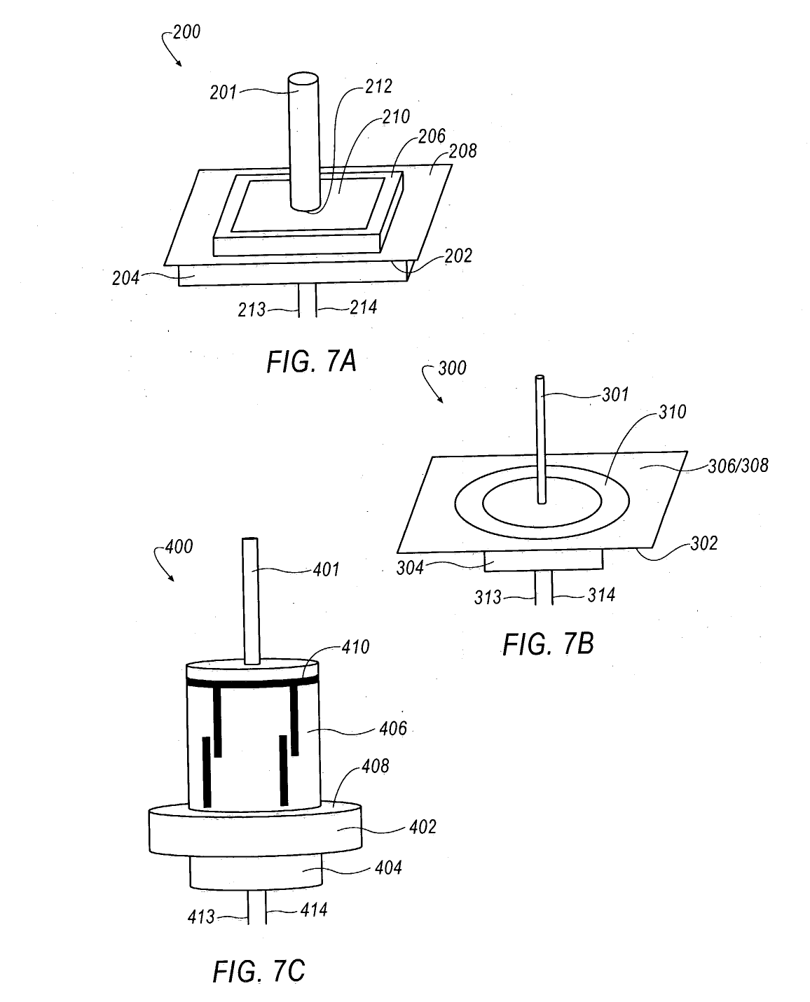

It is also contemplated that other antenna structures may be substituted for the quadrifilar antenna structure. For example, three possible embodiments of the multi-band terrestrial/satellite antenna systems 10, 100 illustrated in FIGS. 5A and 5B are proposed in FIGS. 7A-7C at 200, 300, and 400. The antennas implemented in the antenna system 10, 100 may alternatively be a patch antenna 200 (FIG. 7A), a loop antenna 300 (FIG. 7B), or a coupled-loop antenna 400 (FIG. 7C). As illustrated, each antenna 200, 300, 400 includes a terrestrial antenna element 201, 301, 401 and associated AM/FM cables 213, 313, 413 and SDARS/SAT/TER cables 214, 314, 414. Each antenna 200, 300, 400 may be coupled to a structural element, such as a circuit board 202, 302, 402) or substrate 206, 306, 406 and an LNA 204, 304, 404. Each antenna 200, 300, 400 may also include a weatherproofing material (not shown) that may be applied to its exterior surface for protection against the deteriorating effects of rain, sunshine, etc. Additionally, a binding agent (not shown) may also be applied to the interior surface of the antennas 200, 300, 400 when fabricated into the final form as shown in FIGS. 7A-7C.

Referring specifically to FIG. 7A, the patch antenna 200 may also include a circuit board 202, which has ground plane 208 on both sides of the circuit board 202, positioned under the substrate 206, and a conductive area 210 positioned over the LNA 204, which includes a feed point 212. The feed point 212 receives a pin (not shown) that extends through the LNA 204 for assembly and electrical communication purposes, which is subsequently soldered for directly connecting the antenna assembly. If any of the antennas 200, 300, 400 are positioned on glass a conductive adhesive may be app lied to a surface of the antenna 200, 300, 400 to permit attachment thereto. Even further, if any of the antennas 200, 300, 400 are secured to an instrument panel or package shelf, the antenna 200, 300, 400 may include a bezel, nut, and bolt, and LNA housing (not shown). Yet even further, if any of the antennas 200, 300, 400 are secured to the outer glass frame portion, fender, or roof, the antenna 200, 300, 400 may also be secured via the bezel, nut, and bolt, and LNA housing combination about an OEM supplied passage for an AM/FM antenna as discussed in relation to FIGS. 5A and 5B.

Referring now to FIG. 7B, the loop antenna 300 also includes a generally planar substrate/circuit board 306/308, and a generally circular or oval conductive area 310. As illustrated, the circuit board 302, may act not only as a planar substrate 306, but also as a ground plane 308. FIG. 7C illustrates an alternative embodiment of the loop antenna 300, such that the conductive element 410 is wrapped or disposed upon a generally tubular or cylindrical substrate 406 that is positioned over the ground plane 408. As seen in FIG. 7C, the conductive element 410 is essentially a loop that is wrapped about the cylindrical substrate 406. As illustrated, the conductive element 410 comprises at least one loop portion with conductive strips that extend in a generally perpendicular pattern from the loop. According to the illustrated embodiments of the antennas in FIGS. 7A and 7B, the antennas 200, 300 may be directly coupled to the LNA 204, 304 via a soldering technique that includes a feed point at, on, or about the conductive element 210, 310 as described above. Alternatively, the conductive elements 410 of the antenna 400 illustrated in FIG. 7C are parasitic elements and are parasitically coupled with respect to the main conductive element 410 where the main conductive element 410 is directly coupled to the LNA 404.

It is known that antenna impedance is referenced from the ground; therefore, it is preferable to introduce the ground plane 208, 308, 408 on circuit boards 202, 302, 402 in the design of the antennas 200, 300, 400 to avoid undesirable ripple to obtain a smooth polar response. It is preferable to maintain a minimum circuit board ground plane 208, 308, 408 of approximately 100 sq-mm or 100 mm-diameter regardless of antenna position. If the antenna 200, 300, 400 is located on the glass then ground plane 208, 308, 408 may be introduced without any structural alterations to the antenna 200, 300, 400; however, if the antenna 200, 300, 400 is located on the front or rear dash, the ground plane 208, 308, 408 is not effected because the a ground plane already exists on the front or rear dash. Although not illustrated in FIGS. 5A and 5B, it is also contemplated that the antenna systems 10, 100 may also include a ground plane as well. Referring to FIG. 7A, the dielectric dimensions, dielectric constant, and dimensions of the conductive patch element 210 and the ground plane 208 determine the operating characteristics of the patch antenna 200. According to one embodiment of the invention, the patch antenna 200 may be defined to include an approximate surface area of 1 square inch and height of approximately 4 mm to 6 mm. The conductive patch element 210 may be approximately 0.5 square inches. Referring to FIG. 7B, the loop or micro-strip antenna 300 may be etched on a low-loss dielectric. The loop antenna 300 operates in the TM21 mode and yields adequate performance for elevation angles approximately equal to 20 to 60 degrees and degraded performance at higher angles such as 70 to 90 degrees.

Referring now to FIG. 7C, the ground plane 408, diameter, and length of the conductive elements 410 determine the operating characteristics of the coupled loop antenna 400. According to one embodiment of the invention, the loop perimeter length may be approximately 1/2 wavelength and the height may be approximately equal to 30 mm. Referring back to FIGS. 5A-6, the diameter, height, and pitch angle of helical conductive elements 44 determine the operating characteristics of the quadrifilar antenna 12, 102. According to one embodiment of the invention, the quadrifilar antenna 12, 102 may include a diameter approximately equal to 20 mm and a height ranging from 6.0 cm to 6.5 cm.

Although not illustrated, it is contemplated that any desired alternative antenna may be implemented in the design of the antenna system 10, 100 other than the antenna systems as illustrated in FIGS. 7A-7C. For example, an alternative antenna structure may include a patch antenna incorporating a plurality of micro-strips that have a specific impedance when placed on the glass, which is similar to known printed glass antennas except for the fact that that the micro-strip patch antenna is pre-tuned by the manufacturer prior to being located on the glass. Another alternative antenna that may be applied to the antenna system 10, 100 is a cross-dipole antenna to receive terrestrial signals that include AM/FM and SDARS signals. Essentially, the cross-dipole antenna may comprise two circuit boards each including a dipole that are crossed at a 90° angle. Feed points of the circuit boards may be varied in any desirable polarization such as a horizontal, vertical, left-hand, right-hand polarization, by varying tapping points 90°, 180°, or 270°.

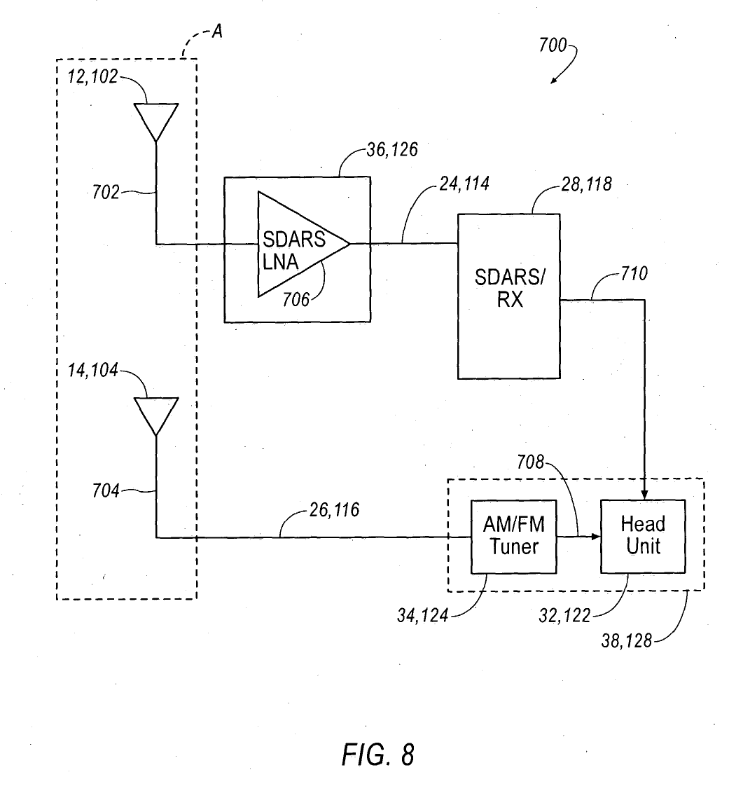

Referring now to FIG. 8, a schematic block diagram of the combined multi-band terrestrial and satellite antenna system 10, 100 for reception of AM, FM, satellite and terrestrial retransmitted signals is shown according to one embodiment of the invention at 700. Connected to each single element antenna 12, 102 and 14, 104 are output cables 702 and 704, respectively, which may be an integrated antenna, A. The cable 702 is a single element satellite and terrestrial output cable and the cable 704 is an AM/FM terrestrial output cable. The single element satellite and terrestrial output cable 702 is input to the LNA housing 36,126, which includes a SAT/LNA 706. Correlating to FIGS. 5A and 5B, each combined multi-band terrestrial/satellite antenna system 10, 100 includes two cables. A single output cable is seen as the output of the SAT/LNA 706, which is SDARS/SAT/TER cable 24, 114, and at the AM/FM terrestrial antenna 14, 104, which is, essentially, the output cable 704 that functions as the AM/FM cable 26, 116. Depending on the positioning of the system 10, 100 in the vehicle, one possible implementation of the antenna system 10, 100, may call for the cables 24, 114 and 26, 116 that are up to 15 feet in length; however, is preferable to limit the length of the cables 702, 704 such that the low noise figures sent to the SAT/LNA 706 and AM/FM Tuner 34, 124 are maintained.

As illustrated, the output of SAT/LNA 706 is connected to the SDARS/SAT/TER cable 24, 114. Referring also to FIGS. 5A and 5B, the SDARS/SAT/TER cable 24, 114 is connected directly to SDARS/RX 28, 118, which carries the amplified signal received by single element satellite and terrestrial antenna 12, 102. The output of the SDARS/RX 28, 118 is an SDARS audio cable 710, which is input to the head unit 32, 122. As explained above, the SDARS/SAT/TER cable 24, 114 carriers satellite transmitted RF signals and terrestrial retransmitted signals of the same satellite transmitted signals. The output of AM/FM antenna 14, 104 is the multi-band antenna output cable 704, which is the AM/FM cable 26, 116, which is input to AM/FM tuner 34, 124, the output of which is connected to head unit 32,122 via an AM/FM tuner output cable 708. As explained above, the head unit 32, 122 also receives the SDARS/Audio cable 710, which is an output from SDARS/RX 28, 118. Essentially, once a down-converted satellite transmission signal is received by the head unit 32, 122 the signal may then be processed and converted to an audio signal. Likewise, the output of AM/FM tuner 34, 124 is a down-converted signal which the head unit 32, 122 can process and output as audio, to speakers (not shown). The signals contained in SDARS audio cable 710 and AM/FM tuner output cable 708 may be either analog or digital signals.

Multiple installation arrangement embodiments of the combined multi-band terrestrial/satellite antenna 10, 100 for the vehicle are illustrated in FIGS. 9A-9E. Although either the retractable or fixed antenna 10, 100 may be implemented in any of the embodiments shown in FIGS. 9A-9E, the antenna systems shown in FIGS. 9A-9E are for illustrative purposes only and are not meant to limit the invention. Referring initially to FIG. 9A, two heights of the fixed antenna 100 are illustrated. The first height, h, is the height of satellite antenna 102, and the second height, H, is the height of the roof 504 of the vehicle 502. An angle, φ, is formed by a vertical line derived from first height, H, and the second height, h, and a horizontal line is derived of a length, l. The length, l, is the distance between a vertical line established by the multi-band terrestrial/satellite antenna 100 and apex of the roof 504 closest to where combined multi-band terrestrial/satellite antenna 100 is located. Angle, φ, should be less than 20°, in order to provide satisfactory reception from a geosynchronous orbit satellite at northerly latitudes. Angle, φ, is equal to tan⁻¹((H−h)/(l)).

Three factors effect the angle, φ. The first factor is that for a given length, l, and second height, H, making the first height, h, greater would reduce the angle, φ. Conversely, reducing the first height, h, would increase the angle, φ (it is well known that most vehicles satisfy the condition φ<20 degrees). The second factor is that for a given second height, H, and the first height, h, making the length, l, longer, would reduce angle φ. Conversely, reducing the length, l, would increase the angle φ. And lastly, for a given length, l, and first height, h, making the second height, H, shorter, would reduce the angle φ. Conversely, increasing the second height, H, would increase the angle φ.

Therefore, it can be seen that in some circumstances, the angle, φ, would be too great if configured as shown. In these circumstances, a spacer may be placed under satellite antenna 102 to raise it up making first height, h, greater and thereby reducing the angle, φ. These relationships are shown below:

$$Angle ϕ = {tan}^{- 1} ( \frac{H - h}{l} )$$

$$Tan 20 ° = 0.363 \\ ∴ \frac{H - h}{l} \leq 0.363$$

Referring now to FIGS. 9B-9E, each Figure illustrates the installation of an alternative embodiment of the combined multi-band terrestrial/satellite antenna in a vehicle 502, according to another embodiment of the invention. In FIG. 9B, the satellite antenna 102 is configured to ride on the uppermost or highest portion of the terrestrial antenna 104. In this manner, the previously described restrictions on the angle between the roof 504 of the automobile 502 and the satellite antenna 102, for all practical purposes, disappear. In this alternative embodiment, the satellite antenna 102 is located on the top, or highest vertical portion of a fixed or retractable terrestrial antenna 104. If the terrestrial antenna 104 is fixed, then the embodiments of FIGS. 9B and 9C do not apply. That is, the combined satellite and terrestrial antenna structure would be as illustrated in FIG. 9B, where the satellite antenna 102 would be located at or near the top of the terrestrial antenna 104. Of course, if the terrestrial antenna 104 is fixed, the satellite antenna 102 can be located at any point from the top to the bottom of the terrestrial antenna 104, and in most of those positions, the angular restriction would not be applicable.

Alternatively, as seen in FIGS. 9C and 9D, the terrestrial antenna 104, as mentioned above, may be a retractable antenna. In this case, it will descend into a suitable recessed area in the vehicle 502, such that it resides above or completely within a recessed area of the vehicle 502. The advantage of the embodiments of FIGS. 9B-9D is that the angular restriction discussed above for the satellite antenna fixed in position at the base of the terrestrial antenna 104 is no longer an issue because it rides either even with or above the roof of the vehicle 502. This improves reception capabilities of the satellite transmitted signals.

In yet another embodiment of the invention as illustrated in FIG. 9E, the combination antenna 102, 104 may be a roof-mount antenna such that the antenna 102, 104 is located about an OEM supplied passage, as explained above. As illustrated, the satellite antenna 102 may be concentrically placed about the terrestrial antenna 104 within a bezel 108, as explained above. Because the antenna is located about the roof, the signal performance is improved because the physical obstruction of the roof 504, in view of the implementations in FIGS. 9A-9D, are for all purposes, eliminated. An antenna positioned on the roof 504 may be restricted in height to make the vehicle 502 aesthetically pleasing to the eye. In this implementation, it may be preferable to include a ‘low profile’ antenna, such as a patch, loop, or coupled-loop antenna, as illustrated in FIGS. 7A-7C. However, it is important to consider that if the height of the antenna is limited, signal performance may be weakened.

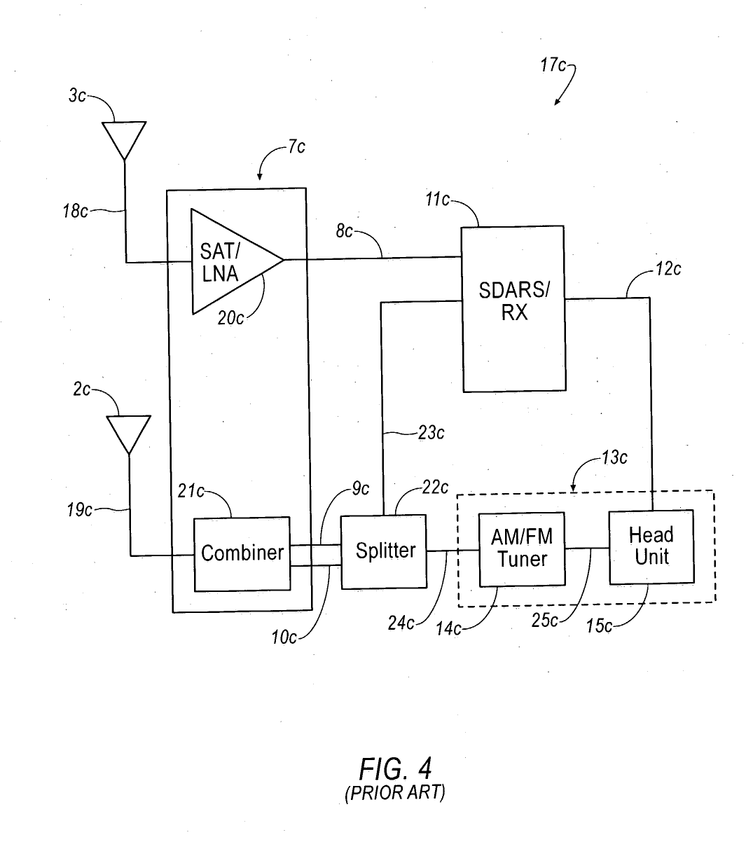

Essentially, the satellite element provides a correlated output by providing the satellite and terrestrial retransmitted signal as a single output. Conversely, as seen in FIG. 3, instead of requiring two distinct antennas that have three cables extending therefrom to function in providing the satellite signal (SDARS/SAT cable 8c), the terrestrial retransmitted satellite signals (SDARS/TER cable 9c), and the AM/FM terrestrial signals (AM/FM cable 12c), the present invention include a single antenna element, as applied to SDARS signals, having two cables that provides satellite and terrestrial retransmitted satellite signals over a single cable (SDARS/SAT/TER cable 24, 114) and AM/FM terrestrial signals over a single cable (AM/FM cable 26, 116), respectively. The ability to provide a single SDARS antenna element not only eliminates the SDARS/TER cable 9c, but it also reduces the complexity and design geometry of the system 10, 100 by eliminating the need for the SDARS/TER cable 9c, a combiner 21c, splitter 22c, an SDARS cable 23c, and an AM/FM/splitter cable 24c. Accordingly, by eliminating the folded-dipole from the design of the antenna system 10, 100, the satellite retransmitted terrestrial signals may be provided over the SDARS/SAT cable 8c (i.e. the SDARS/SAT/TER cable 24, 114 according to the invention) and the overall complexity and design geometry may be significantly reduced such that the AM/FM cable 26, 116 directly provides AM/FM terrestrial signals to the AM/FM Tuner 34, 124. Even further, cable lengths and signal losses may be limited to a greater degree as a result of the decreased complexity of the design of the antenna system 10, 100.

Although discussion of the combined satellite/terrestrial antenna and combined satellite/terrestrial antenna system 10, 100 has focused on the particular application of an automobile, it should be readily apparent to one skilled in the art, that the combined satellite/terrestrial antenna system 10,100 can be just as easily used in an aircraft, boat, train, mobile home, recreational vehicle or truck. Each installation should ideally follow the same requirements as discussed with respect to FIG. 9A, i.e., that angle, φ, be less than 20°. Care should be taking when installing combined terrestrial/satellite antenna so that such installation does not defeat the minimum angle criterion. Even further, although it is preferable to implement the antenna designs on the basis of an OEM supplied hole to feed the cables, it is also contemplated that the antenna designs may be implemented in an after-market installation as well.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A combined satellite and terrestrial antenna system for a structure, comprising:
a terrestrial antenna including a multi-band terrestrial antenna mounted on a mounting assembly including a low noise amplifier circuit and a bezel, wherein the bezel is adapted to contain the low noise amplifier;
a satellite antenna concentrically mounted with respect to the terrestrial antenna;
a satellite receiver; and
the mounting assembly connected to the satellite receiver for reception of satellite and satellite retransmitted signals by a satellite-terrestrial-retransmitted-satellite cable and an AM/FM receiver for reception of AM/FM terrestrial signals by a terrestrial AM/FM cable.

2. The combined satellite and terrestrial antenna system for a structure according to claim 1, wherein:
the satellite antenna is configured to receive SDARS signals.

3. The combined satellite and terrestrial antenna system for a structure, according to claim 2, wherein the satellite antenna comprises:
a quadrifilar helix antenna.

4. The combined satellite and terrestrial antenna system for a structure, according to claim 2, wherein the satellite antenna comprises:
a patch antenna.

5. The combined satellite and terrestrial antenna system for a structure, according to claim 2, wherein the satellite antenna comprises:
a loop antenna.

6. The combined satellite and terrestrial antenna system for a structure, according to claim 2, wherein the satellite antenna comprises:
a coupled-loop antenna.

7. The combined satellite and terrestrial antenna system for a structure according to claim 1, further comprising:
both the terrestrial antenna and satellite antenna mounted at a common location on the structure, such that the angle formed by the difference in height between the top of an obstruction and the height of the satellite antenna, and the distance from the obstruction and the combined concentrically mounted satellite and multiband terrestrial antenna is less than 20 degrees.

8. The combined satellite and terrestrial antenna system for a structure according to claim 1, wherein the AM/FM receiver comprises:
a head unit; and
an AM/FM tuner.

9. The combined satellite and terrestrial antenna system for a structure according to claim 1, wherein the low noise amplifier circuit comprises:
a satellite low noise amplifier with a first input connected to a first end of a satellite output, wherein the output of the low noise amplifier is the SDARS/SAT/TER cable

10. The combined satellite and terrestrial antenna system for a structure according to claim 1, wherein the structure is selected from the group consisting of an automobile, a recreational vehicle, a house, a building, a train and an aircraft.

11. The combined satellite and terrestrial antenna system for a structure according to claim 1, wherein the structure is a roof of an automobile.

12. The combined satellite and terrestrial antenna system for a structure according to claim 1, wherein the structure is a fender of an automobile.

13. The combined satellite and terrestrial antenna system for a structure according to claim 1, wherein:
the satellite antenna is mounted on the uppermost portion of the terrestrial antenna.

14. The combined satellite and terrestrial antenna system for a structure according to claim 1, wherein:
the satellite antenna is mounted in a position lower than the terrestrial antenna.

15. The combined satellite and terrestrial antenna system for a structure according to claim 1, wherein the terrestrial antenna is a retractable terrestrial antenna.

16. The combined satellite and terrestrial antenna system for a structure according to claim 1, wherein the satellite and terrestrial antenna retract to a location within the structure.

17. The combined satellite and terrestrial antenna system for a structure according to claim 1, wherein the combined satellite and terrestrial antenna retract to a location on the surface of the structure.

18. The combined satellite and terrestrial antenna system for a structure according to claim 1, wherein the satellite antenna is mounted on the uppermost portion of the terrestrial antenna.

19. The combined satellite and terrestrial antenna system for a structure according to claim 1, wherein the satellite antenna is mounted at any position on the terrestrial antenna.

20. The combined satellite and terrestrial antenna system for a structure according to claim 1, wherein the terrestrial antenna is a retractable terrestrial antenna.

21. The combined satellite and terrestrial antenna system for a structure according to claim 1, wherein the combined satellite and terrestrial antenna retract to a location within the structure.

22. The combined satellite and terrestrial antenna system for a structure according to claim 1, wherein the combined satellite and terrestrial antenna retract to a location on the surface of the structure.

23. A method for mounting a combined satellite and terrestrial antenna system on a structure comprising the following steps:
mounting a terrestrial antenna on a mounting assembly;
mounting the satellite antenna concentrically with the terrestrial antenna;
mounting the mounting assembly in a mounting hole on a structure, the mounting assembly comprising a low noise amplifier circuit and a bezel, the bezel adapted to contain the low noise amplifier;
locating satellite receiver hardware in proximity to the combined satellite and terrestrial antenna system; and
connecting the satellite antenna with a satellite-terrestrial-retransmitted-satellite cable for reception of satellite and satellite retransmitted signals
connecting the terrestrial antenna with an AM/FM cable for reception of AM/FM terrestrial signals.

24. The method for mounting a combined satellite and terrestrial antenna system on a structure according to claim 23, wherein the step of mounting the terrestrial antenna in a mounting hole and mounting the satellite antenna concentrically with the terrestrial antenna comprises:
mounting both the terrestrial antenna and satellite antenna mounted at a common location on the structure, such that the angle formed by the difference in height between the top of an obstruction and the height of the satellite antenna, and the distance from the obstruction and the combined concentrically mounted satellite and multiband terrestrial antenna is less than 20 degrees.

25. The method for mounting a combined satellite and terrestrial antenna system on a structure according to claim 23, wherein the structure is selected from the group consisting of an automobile, a recreational vehicle, a house, a building, a train and an aircraft.

26. The method for mounting a combined satellite and terrestrial antenna system on a structure according to claim 25, wherein the obstruction comprises:
a roof of the automobile.

27. The method for mounting a combined satellite and terrestrial antenna system on a structure according to claim 25, wherein the obstruction comprises:
a fender of the automobile.
